(19) United States
(12) Patent Application Publication
(10) Pub. No.: US 2009/0308816 A1
(43) Pub. Date: Dec. 17, 2009

(54) IN-SITU PRECIPITATION THROUGH MICROBIALLY MEDIATED IRON DISTRIBUTION AND IRON OXYHYDROXIDE FORMATION

(76) Inventors: John F. Horst, Newton, PA (US); Jeff Gillow, Highlands Ranch, CO (US); Suthan S. Suthersan, Yardley, PA (US)

Correspondence Address: SHERIDAN ROSS PC, 1560 BROADWAY, SUITE 1200, DENVER, CO, 80202, US

(21) Appl. No.: 12/477,904

(22) Filed: Jun. 3, 2009

Related U.S. Application Data
(60) Provisional application No. 61/058,532, filed on Jun. 3, 2008.

(51) Int. Cl. C02F 1/52; C02F 1/62

(52) U.S. Cl. 210/719

(57) ABSTRACT

The invention provides methods of precipitating metals from groundwater in a form that will remain stable under the aerobic conditions typical of most aquifers eliminating secondary water quality issues associated with reducing/anaerobic precipitation technologies.

### RELATED APPLICATIONS

The present application claims the benefit of priority under 35 U.S.C. § 119(e) to U.S. Provisional Application Ser. No. 61/058,532, filed Jun. 3, 2008, which is incorporated herein by this reference in its entirety.

### FIELD OF THE INVENTION

The invention is generally related to environmental remediation of metal contaminants.

### BACKGROUND OF INVENTION

Access to fresh water resources is becoming scarcer worldwide due to population growth and climate change and one in six people in the world do not have reliable access to clean water. Water contamination associated with soluble toxic metals (inclusive of metalloids and radionuclides) is a major factor in this problem, and can range from relatively small impacts in densely populated urban areas to regional degradation of water resources. Contaminant sources are related to human activity and to naturally occurring metals present in aquifer minerals. The latter represents a world health crisis that can render entire aquifers dangerous for human consumption. Examples include elevated concentrations of arsenic and chromium in groundwater resources of the Mojave River Valley of the U.S. due to evapoconcentration and naturally alkaline conditions; selenium in groundwater resources of the Canary Islands (Spain) and the Massif Central (France) associated with volcanic soils; and arsenic in groundwater resources of Bangladesh and India.

There are fewer technologies available for treating metals impacts in groundwater than there are for treating organic contaminants. This relates to the fact that unlike organics, metals cannot be degraded or be easily driven into a vapor phase to enhance their recovery. Conventional approaches for dealing with dissolved metals have often focused on extraction and above-ground treatment (for mass removal and/or containment), or in-situ sequestration/precipitation technologies that require the physical emplacement of sorptive materials.

Methods of precipitating metals in-situ, in mineral forms that are not susceptible to oxidative dissolution, are needed for aquifers that are naturally aerobic. This is one way of assuring the long-term stability of the resulting metal precipitates and the sustainability of the overall remedy. Ferric iron oxyhydroxides (such as freshly precipitated ferrihydrite) fit into this category. Their ability to sequester metals is attributable to the fact that their charged surfaces engage in both coulombic (electrostatic) and Lewis Acid-Base (electron sharing) interactions. Depending on the pH of the groundwater system, which controls the surface charge of the iron minerals, these ferric iron oxyhydroxides are effective for metals that form oxyanions and/or function as strong ligands such as arsenic(V) and arsenic(III) (Raven, K. P., et al. 1998. Arsenite and arsenate adsorption on ferrihydrite: kinetics, equilibrium, and adsorption envelopes. Environmental Science and Technology 32(3): 344-249) as well as cationic metals such as lead (Trivedi, P., et al. 2003. Lead sorption onto ferrihyrdite. 1. A macroscopic and spectroscopic assessment. Environmental Science and Technology 37: 908-914), copper (Karthikeyan, K. G., et al. 1998. Role of surface precipitation in copper sorption by the hydrous oxides of iron and aluminum. Journal of Colloid and Interface Science 209: 72-28), zinc (Trivedi, P., et al. 2004. Mechanistic and thermodynamic interpretations of zinc sorption onto ferrihydrite. Journal of Colloid and Interface Science 270(1): 77-85), and cadmium (Randall, S. R., et al. 1999. The mechanism of cadmium surface complexation onto iron oxyhydroxide minerals. Geochimica et Cosmochimica Acta 63: 2971-2987). Other oxyanions such as molybdenum and vanadium (Brinza, L., et al. 2008. Adsorption studies of Mo and V onto ferrihydrite. Mineralogical Magazine 72(1): 385-388) are also sorbed by ferric iron oxyhydroxides.

The application of ferric iron oxyhydroxides in an in-situ manner is significantly hindered by the fact that the ferric iron is not soluble under normal groundwater conditions of neutral pH and dissolved oxygen in the range of 5-10 mg/L. Additionally, the effective delivery of colloidal or particulate iron is impossible.

Arsenic and metals will sorb to nanoscale zero-valent iron (Kanel, S. R., et al. 2005. Removal of arsenic(III) from groundwater by nanoscale zero-valent iron. Environmental Science and Technology 39: 1291-1298) and this has been suggested as an iron form that is amenable to injection and distribution. But practical field experience with zero-valent iron is limited and most cases have shown that zero-valent iron is too reactive to effectively distribute as it coagulates/precipitates at the injection well. In one approach to overcome this problem, Welch et al. (2008. Welch, A. H., Stollenwerk, K. G., Paul, A. P., Maurer, D. K., and Halford, K. J. In situ arsenic removal in an alkaline clastic aquifer. Applied Geochemistry 23: 2477-2495) injected ferrous iron in the form of ferrous chloride, along with hydrochloric acid to provide a more appropriate pH for iron distribution (the ambient pH of the aquifer was 8 and it was decreased to 5 to enable better iron delivery).

In-situ iron removal has been shown to be a proven technique for decreasing the iron concentration in groundwater. This technique involves the cyclic injection of oxygenated water into an aquifer and withdrawal of the injected water and groundwater. The iron concentrations are typically decreased in the native groundwater due to precipitation of ferric iron oxyhydroxide in the aquifer. This method is used in a number of European countries but has not been used as a water treatment technology for toxic metals (Rott, U., and B. Lamberth. 1993. Groundwater cleanup by in situ treatment of nitrate, iron and manganese. Water Supply 11: 143-156). In-situ iron oxidation has been shown be free of clogging by precipitated iron-oxyhydroxide due to controlled kinetics and numerous electron transfer steps between the dissolved oxygen in the injection water and dissolved iron in ground water (Appelo, C. A. J., et al. 1999. Modeling In Situ Iron Removal from Ground Water. Ground Water 37(6): 811-817).

Thus, there is a need for reliable, generally applicable and cost effective methods to permanently sequester dissolved metal impacts. The techniques of the present invention provide such methods while overcoming many of the disadvantages of the water remediation methods described above.

### SUMMARY OF INVENTION

Many in-situ approaches for metals target precipitation through anaerobic or reducing pathways, resulting in minerals that are susceptible to re-mobilization as aerobic conditions slowly return. The methodology of the present invention provides techniques for the in-situ precipitation of fresh iron oxyhydroxides to permanently sequester dissolved metal contaminants. These methods are injection-based in-situ treatment technologies that are much more attractive than extraction and above-ground treatment or the physical emplacement of sorptive materials, as these remediation techniques described herein are more cost-effective, flexible in application, and require application configurations of limited complexity.

In one embodiment of the invention, groundwater contaminated with one or more metals is remediated by creating a reducing environment in a contaminated aquifer before introducing a source of ferrous iron into the contaminated aquifer. This reducing environment is then reversed to oxidize the ferrous iron to ferric iron causing formation of ferric iron oxyhydroxides that sequester metal contaminants in the groundwater.

The reducing environment may be created by the introduction of a soluble source of degradable organic carbon into the contaminated aquifer, such as a carbohydrate. The degradable organic carbon stimulates rapid microbial growth at the contaminated site to facilitate the production of a reducing environment.

The source of ferrous iron may be ferrous chloride and/or ferrous sulfate. A complexing agent such as a citrate may also be introduced to facilitate distribution of the ferrous iron, and a degradable organic carbon source may also be introduced with the source of ferrous iron.

Reversing the reducing environment may be accomplished by introducing a source of dissolved oxygen into the contaminated aquifer. The dissolved oxygen may be delivered as oxygenated water.

The metal contaminant may include members of group IA, IIA, IIIA, IVA, VA, VIA, IB, IIB, IIIB, IVB, VB, VIB, VIIB, VIII, lanthanides and actinides of the Periodic Table of the Elements and transuranic metals.

The metal contaminants may include arsenic, cadmium, cobalt, chromium, copper, nickel, lead, uranium, plutonium, zinc, gold, silver, platinum and palladium.

### BRIEF DESCRIPTION OF THE DRAWINGS

The accompanying drawings, which are incorporated in and constitute part of the specification, illustrate various embodiments of the invention and together with the general description of the invention given above and the detailed description of the drawings below, serve to explain the principles of these inventions.

FIG. 1 depicts the movement of iron through an aquifer a pathway of high conductivity, along with a photograph of a laboratory test column.

FIG. 2, depicts different injection and circulation methods suitable for use in the methodology of the present invention.

It should be understood that the drawings are not necessarily to scale. In certain instances, details that are not necessary for an understanding of the invention or that render other details difficult to perceive may have been omitted. It should be understood, of course, that the invention is not necessarily limited to the particular embodiments illustrated herein.

### DESCRIPTION OF EMBODIMENTS

The co-precipitation of metal contaminants with iron hydroxides is a common above-ground treatment process used to remove metals from industrial wastewater. The natural abundance of iron (ranked fourth overall in the earth's crust) and its geochemical behavior also makes it an ideal candidate for the in-situ treatment of a wide variety of metals. The ability of ferric iron hydroxide minerals to remove metals from groundwater is attributable to the fact that the metals can chemically bond to the iron mineral surfaces. This can involve both coulombic (electrostatic) and Lewis Acid-Base (electron sharing) interactions and depends on the pH of the groundwater system, which controls the surface charge of the iron minerals. Elements that react with ferric iron hydroxides include heavy metals (lead, copper, nickel, mercury), metalloids (arsenic, selenium), and radioactive elements (uranium, plutonium). Iron is often most effective for metals that form oxyanions such as arsenic, but can also be effective for cationic metals including lead, copper, zinc and cadmium.

Using the in-situ techniques of the present invention, dissolved iron is distributed and converted into fresh ferric iron hydroxides. During this process, the targeted metal contaminants rapidly sorb onto the surfaces of the freshly formed iron hydroxides and become occluded within a matrix of iron minerals as more iron is precipitated. Successful implementation of this treatment approach requires the ability to adequately deliver and distribute ferrous iron in an aquifer. This can be difficult as ferrous iron is highly reactive and is rapidly scavenged through interactions with dissolved oxygen and the aquifer solids. Published attempts to address this have involved the use of chemical reductants or acids to keep the iron in solution, and have almost always involved the use of direct-push injections and uncontrolled fracturing rather than properly constructed injection wells.

This methodology of the present invention overcomes this distribution challenge by the temporary creation of anaerobic/reducing conditions in the treatment area. This helps overcome the effects of oxidation reactions by cycling the iron back to its soluble/reduced form, maintaining enough in solution to support effective distribution. It can also reduce iron sorption to the aquifer by destabilizing the primary aquifer minerals involved in scavenging the iron through sorption. This process is further enhanced where the amount of iron being delivered can overwhelm the supply of reactive sulfide or carbonate. At sites where this approach was taken to facilitate iron distribution, the iron distribution is still retarded compared to a conservative tracer, but has been successfully distributed at concentrations of 50 ppm over 14 meters from an injection point.

Thus, one embodiment of the invention is a method of creating temporary reducing and anaerobic conditions to facilitate the distribution of dissolved iron in the subsurface of a contaminated site. In the absence of oxygen, and in a reducing environment (low redox potential (Eh) conditions), the stable form of iron is the ferrous form. Under these conditions the iron is soluble and can be effectively distributed in an aquifer. Thus, the ability to distribute the iron in the subsurface is enhanced in reducing environments in which iron is maintained in ferrous form. The temporary reducing environment works by overcoming the effects of oxidation reactions, enabling the iron to cycle back to a reduced form. It can also reduce sorption by destabilizing the primary aquifer minerals involved in scavenging the iron through sorption. This is further enhanced where the amount of iron being delivered can overwhelm the supply of reactive sulfide or carbonate.

The subsurface is first amended to created the reducing and anaerobic conditions. Suitable amendment(s) include a soluble source of degradable organic carbon to stimulate rapid microbial growth, creating an anaerobic environment in the subsurface. While this approach requires time to condition the aquifer, it is more robust and more cost-effective compared to the use of chemical reductants.

Following this conditioning of the aquifer, a source of ferrous iron, such as ferrous chloride or ferrous sulfate, is introduced. Additionally, complexing agents, such as citrate, may be also be introduced to facilitate distribution of the ferrous iron. The application of a degradable organic carbon source can be continued during the application of the ferrous iron to maintain the anaerobic environment.

Following the iron distribution, the reductive poise of the anaerobic environment must be overcome to promote oxidation of the ferrous iron to ferric iron, which allows the precipitation of fresh ferric iron oxyhydroxides. Relying on the natural recharge of electron acceptors would take a very long time. Thus, this component of the process is also engineered and includes the introduction of dissolved oxygen into the treatment site. This can be accomplished by means known to those of skill in the art but preferably includes the injection of oxygenated water through the same injection point used to deliver the ferrous iron source.

The freshly precipitated iron oxyhydroxides created during this phase of the application will sequester heavy metal contaminants impacting groundwater and these precipitates will remain stable in the ambient aerobic aquifer environment.

Metal contaminants that are susceptible to sequestration from contaminated groundwater by the methods of this invention include members of groups IA, IIA, IIIA, IVA, VA, VIA, IB, IIB, IIIB, IVB, VB, VIB, VIIB, VIII, lanthanides and actinides of the Periodic Table of the Elements and transuranic metals.

The methodology of this invention is particularly useful for sequestration of arsenic, cadmium, cobalt, chromium, copper, nickel, lead, uranium, plutonium, zinc, gold, silver, platinum and palladium.

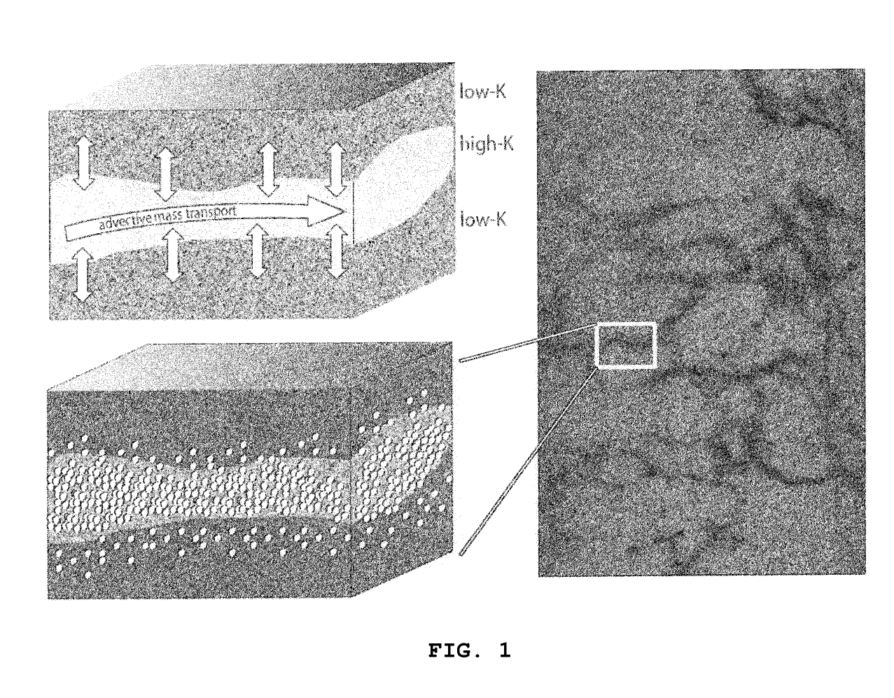

As indicated in the previous section, one of the main challenges of injection-based remediation technologies is to achieve contact between the targeted contaminants and the reagents needed to support the desired reactions. While tracers can provide critical information on lateral coverage via site-specific injection volume-distribution radius relationships, the injection solution will preferentially travel through the contaminated site in zones of higher conductivity. As a result, the iron will predominantly end up precipitating in these preferential pathways, not throughout the entire vertical profile within the area covered. This is depicted in FIG. 1, along with a photograph of a laboratory test column where iron precipitation was observed to occur in preferential pathways created during the column construction.

The ferric-iron solid phase precipitants will then be located in the “highest-value” regions of the aquifer. Because these pathways represent the fraction of the aquifer where groundwater flow is focused and where the vast majority of contaminant flux occurs, the precipitates are positioned to continue removing metals from the groundwater as they move in from upgradient or slowly diffuse out of the lower permeability porespace.

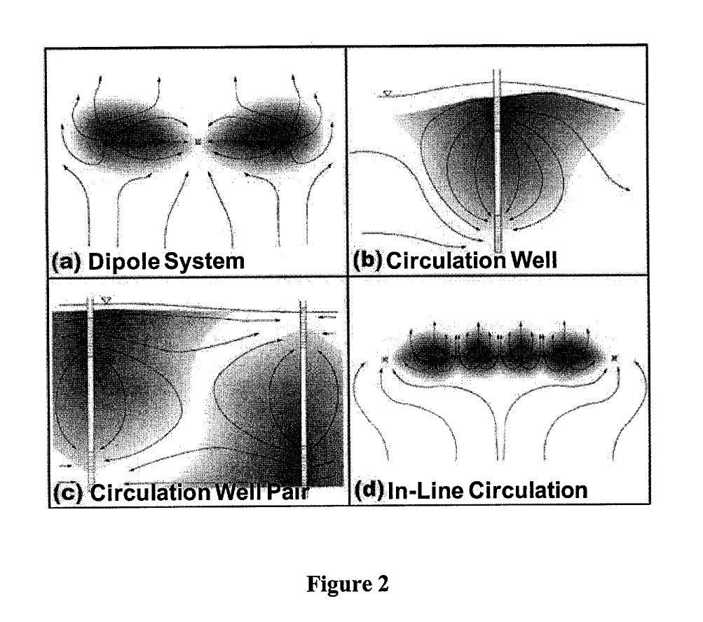

In the field, there are a number of injection approaches that can be used to distribute the iron. As depicted in FIG. 2, these injection approaches range from individual batch injections to recirculation and continuous-delivery methods that are more appropriate for larger volume treatment areas. Equipment setups are fairly simple, and include tanks for mixing and storage, pumps and other equipment for fluid transfer, an oxygen generator to supersaturate water for the final step of the process, and a sand filter to remove solids from oxygenated water prior to injection. Consideration must be given to the potential for equipment fouling, and mitigation measures incorporated as warranted.

Following distribution of the iron, oxygen is be delivered to overcome all of the reductive poise that was established by both the organic carbon and the ferrous iron. There are a number of ways to deliver oxygen to the subsurface, but the preferred method includes the use of oxygenated water. The use of oxygenated water as an oxygen delivery system provides advantages over most alternative oxygen delivery methodologies, including:
1) An aqueous carrier solution will deliver the oxygen through the same pathways that the iron followed, putting it exactly where can be most effective.
2) The same wells and above-ground equipment used for the first two phases can be used for the re-oxidation.
3) The entire payload of oxygen already dissolved in water is available for reaction, eliminating transfer efficiency issues associated with sparging methods.

At standard pressures and typical aquifer temperatures (10 to 15 degrees Celsius), oxygen solubility is generally between 9 and 10 mg/L. In one embodiment of the invention, this dissolved oxygen limit is overcome using a flash gas/liquid contactor. This piece of equipment starts with air, and concentrates the oxygen in the gas phase. Water is then passed through the gas/liquid contactor to facilitate oxygen transfer. Dissolved oxygen concentrations of 30 to 40 mg/L can be achieved in the gas/liquid contactor.

These techniques can be used for source treatment or development of one or more barriers to break up a plume and control its advancement. Where implemented in the form of a barrier, the barrier could be “recharged” as needed. The primary limitation will be the amount of iron needed versus the effective carrying capacity of the aquifer to assimilate additional mineral mass without significantly reducing the conductivity.

The foregoing description of the present invention has been presented for purposes of illustration and description. Furthermore, the description is not intended to limit the invention to the form disclosed herein. Consequently, variations and modifications commensurate with the above teachings, and the skill or knowledge of the relevant art, are within the scope of the present invention. The embodiments described hereinabove are further intended to explain the best mode known for practicing the invention and to enable others skilled in the art to utilize the invention in such, or other, embodiments and with various modifications required by the particular applications or uses of the present invention. It is intended that the appended claims be construed to include alternative embodiments to the extent permitted by the prior art.

What is claimed is:

1. A method of remediating groundwater containing metal contaminants comprising:
creating a reducing environment in a contaminated aquifer;
introducing a source of ferrous iron into the contaminated aquifer;
reversing the reducing environment to oxidize the ferrous iron to ferric iron causing formation of ferric iron oxyhydroxides that sequester metal contaminants in groundwater.

2. The method of claim 1, wherein the creating a reducing environment comprises the introduction of a soluble source of degradable organic carbon into the contaminated aquifer.

3. The method of claim 1, wherein the degradable organic carbon is a carbohydrate.

4. The method of claim 1, wherein the degradable organic carbon stimulates rapid microbial growth at the contaminated site.

5. The method of claim 1, wherein the source of ferrous iron is at least one of ferrous chloride and ferrous sulfate.

6. The method of claim 1, further comprising introducing a complexing agents to facilitate distribution of the ferrous iron.

7. The method of claim 6, wherein the complexing agent is a citrate.

8. The method of claim 1, wherein the source of ferrous iron comprises the introduction of a degradable organic carbon source.

9. The method of claim 1, wherein the reversing of the reducing environment comprises introducing a source of dissolved oxygen into the contaminated aquifer.

10. The method of claim 1, wherein the source of dissolved oxygen comprises oxygenated water.

11. The method of claim 1, wherein the metal contaminant is selected from the group consisting of IA, IIA, IIIA, IVA, VA, VIA, IB, IIB, IIIB, IVB, VB, VIB, VIIB, VIII, lanthanides and actinides of the Periodic Table of the Elements and transuranic metals.

12. The method of claim 1, wherein the metal contaminant is selected from the group consisting of arsenic, cadmium, cobalt, chromium, copper, nickel, lead, uranium, plutonium, zinc, gold, silver, platinum and palladium.

13. A method of remediating groundwater containing metal contaminants comprising:
creating a reducing environment in a contaminated site by aquifer by injecting a degradable organic carbon into the contaminated site;
introducing a source of ferrous iron selected from the group consisting of ferrous chloride and ferrous sulfate into the contaminated aquifer;
reversing the reducing environment by introducing oxygenated water into the contaminated site to oxidize the ferrous iron to ferric iron causing formation of ferric iron oxyhydroxides that sequester heavy metal contaminants in groundwater.
